(19) United States
(12) Patent Application Publication
(10) Pub. No.: US 2006/0238470 A1
(43) Pub. Date: Oct. 26, 2006

(54) LTPS display panel and manufacturing process thereof

(75) Inventors: Tsau Hua Hsieh, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/114,742

(22) Filed: Apr. 25, 2005

(30) Foreign Application Priority Data
Apr. 23, 2005 (TW) 93111377

(51) Int. Cl. G09G 3/36

(52) U.S. Cl. 345/87

(57) ABSTRACT

An LTPS (low temperature poly-silicon) display panel includes a display area and a pair of driving circuit areas. The display area is fabricated by cutting from a display substrate. The driving circuit areas are fabricated by cutting from an insulated substrate having a poly-silicon film thereon. The driving circuit areas are electrically connected with the display area. This approach reduces the impediment to uniformity that is caused by various different processes, and thus improves the yield rate and reduces production costs.

### FIELD OF THE INVENTION

The present invention relates to a thin film transistor substrate of low temperature poly-silicon (LTPS), and a process for manufacturing the substrate. The instant application relates to the copending application with an unknown serial number, titled “LTPS TFT SUBSTRATE AND MANUFACUTRING PROCESS THEREOF” having the same applicants and the same assignee with the instant application.

### BACKGROUND

The amorphous silicon thin film transistor liquid crystal display (a-Si TFT-LCD) has been a major product in the market as an alternative to the conventional cathode ray tube (CRT) display, because of the a-Si TFT-LCD's thinness and light weight. However, information technology is continuing to advance rapidly, and the market requirements for resolution and data transmittance have become so high that many a-si TFT-LCDs can no longer meet these requirements. Thus, the industry has developed a superior technology, which is known as low temperature poly-silicon thin film transistor (LTPS TFT) technology. The superiority of an LTPS TFT-LCD is that the driving circuit can be fabricated on the glass substrate, which is known as system on glass—(SOG). This means that the cost of the integrated driving circuit can be reduced, while still meeting stringent requirements for resolution and data transmittance.

The general technology of LTPS TFTs at least comprises thin film deposition, laser annealing, lithography, and etching processes. These processes can manufacture the thin film transistors and the pixel electrodes on the glass substrate. The laser annealing process is the most important step in these processes. The success or otherwise of the laser annealing process greatly impacts the characteristics of the thin film transistors produced.

A prior art LTPS TFT-LCD is found in U.S. patent application publication number 2004/0018649, which was published on Jan. 29, 2004. Referring to FIG. 5, this is an isometric structural view of an LTPS display panel according to the prior art. The LTPS display panel 100 is manufactured by performing the following steps. First, a glass substrate 110 to be the base of the LTPS display panel 100 is provided. An amorphous silicon film 112 is formed on a surface of the glass substrate 110. The amorphous silicon film 112 comprises a first area 114 and a second area 116. The first area 114 is located in the center of the amorphous silicon film 112. The second area 116 is at the periphery, and has a slanted wall. The thickness distribution of the slanted wall determines the boundary condition of the laser annealing process. The thickness of the amorphous silicon film 112 in the first area 114 is a predetermined value. Then, the substrate 110 is put into a chamber for excimer laser annealing, to make the amorphous silicon film 112 transform into a poly-silicon film. When the thickness of the amorphous silicon film in the boundary condition is larger than a threshold, usually 400Å, an ablation phenomenon occurs in the amorphous silicon film such that any film higher than the threshold thickness is removed. Finally, a driving circuit area and a display panel area are produced in the glass substrate 110.

Referring to FIG. 6, this is a structural plan view of another LTPS display panel according to the prior art. The LTPS display panel 200 comprises an insulating substrate 220, a driving circuit area 210, and a display panel area 230. The driving circuit area 210 and the display panel area 230 are connected together. A plurality of driving circuits 211 is set in the driving circuit area 210. A plurality of pixel units 222 is set in the display panel area 230. Each driving circuit 211 is set corresponding to each pixel unit 222. The excimer laser annealing process is repeated several times to make the thin film transistors on the substrate 220, so the characteristic of each thin film transistor should be different. The requirement (±10˜100 mV) of the characteristic uniformity of the TFTs in the driving circuit area 210 is much higher than the requirement (±1˜2V) of the TFTs in the display panel area 230. Furthermore, the layout of the general LTPS display panel 200 is such that each driving circuit 211 is distributed corresponding to the pixel unit 222 in the substrate 220. Thus, it is hard to achieve the uniformity requirements during the production process. When the uniformity of the process is lower than a threshold requirement, some driving circuits 211 are destroyed, and the display panel area 230 corresponding to the lost driving circuits 211 is also destroyed. This decreases the yield rate and increases costs.

In view of the above, it is desired to provide a new LTPS display panel to solve the problems of the low yield rate and high costs of conventional low-uniformity LTPS display panels.

### SUMMARY

An object of the present invention is to provide an LTPS display panel to solve or at least mitigate the prior art drawbacks of low yield rate and high costs.

Another object of the present invention is to provide a method for manufacturing the above-described LTPS display panel.

The present invention provides a LTPS display panel that includes a display area and one or more driving circuit areas. The display area is fabricated by cutting from a display substrate. The driving circuit areas are fabricated by cutting from an insulated substrate having a poly-silicon film thereon. The driving circuit areas are electrically connected with the display area.

The present invention further provides a method of manufacturing the LTPS display panel, which comprises the following steps. First, two substrates are provided. One is a display substrate and the other is an insulative substrate. The display substrate includes a plurality of display areas. Second, a poly-silicon film is formed on the insulative substrate, and then a plurality of driving circuits is formed on the poly-silicon film. Third, the display substrate is cut to form a plurality of display areas, and the insulative substrate is cut to form a plurality of driving circuit areas. Finally, one of the cut display areas and at least one of the cut driving circuit areas are electrically connected to form the LTPS display panel.

Compared to the prior art, the present invention provides a technology to manufacture the driving circuit areas and the display area separately, and to centralize the driving circuits in the same substrate. This approach reduces the impediment to uniformity that is caused by various different processes, and thus improves the yield rate and reduces production costs.

Other objects, advantages, and novel features will become more apparent from the following detailed description when taken in conjunction with the accompanying drawings, in which:

### BRIEF DESCRIPTION OF THE DRAWINGS

FIG. 1 is a structural plan view of an LTPS display panel according to an embodiment of the present invention;

FIG. 2 is a structural plan view of an insulated substrate according to an embodiment of the present invention;

FIG. 3 is a structural plan view of a display substrate according to an embodiment of the present invention;

FIG. 4 is a flow chart of an exemplary method for manufacturing the LTPS display panel of FIG. 1;

FIG. 5 is an isometric structural view of an LTPS display panel according to the prior art; and

FIG. 6 is a structural plan view of another LTPS display panel according to the prior art.

### DETAILED DESCRIPTION OF THE PRESENT EMBODIMENTS

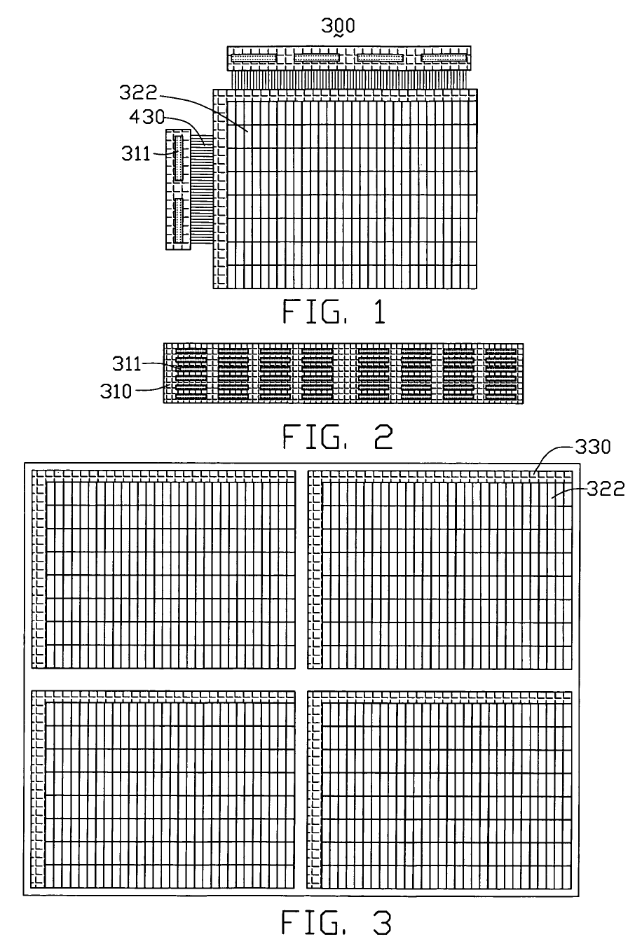

FIG. 1 is a structural plan view of an LTPS display panel according to an embodiment of the present invention. FIG. 2 is a structural plan view of an insulated substrate according to an embodiment of the present invention. FIG. 3 is a structural plan view of a display substrate according to an embodiment of the present invention. The LTPS display panel 300 comprises a plurality of driving circuits 311, a plurality of pixel units 322, and a soft circuit board. In this embodiment, pins of the driving circuits 311 and pins of TFTs in the pixel units 322 are connected to each other by a pair of soft circuit boards 430. In other embodiments, the soft circuit boards 430 could be replaced by any other suitable conducting material and/or means. The driving circuits 311 and the pixel units 322 are manufactured on separate and differently sized substrates 310, 330. The driving circuits 311 are set in the driving circuit substrate 310, and the pixel units 322 are set in the display substrate 330. A display area comprises a required amount of pixel units 322 cut from the display substrate 330. A pair of driving circuit areas corresponding to the display area is cut from the driving circuit substrate 310. The LTPS display panel is made by interconnecting the display area and the driving circuit areas using the soft circuit boards 430.

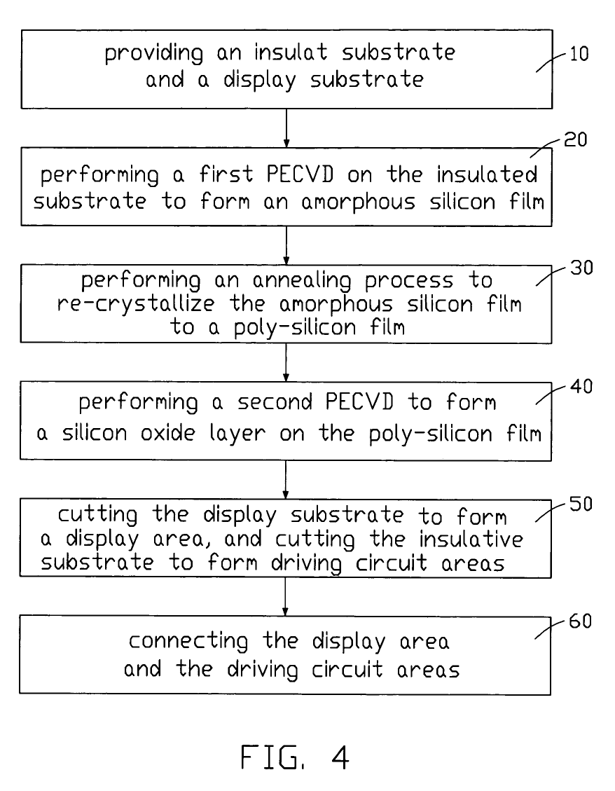

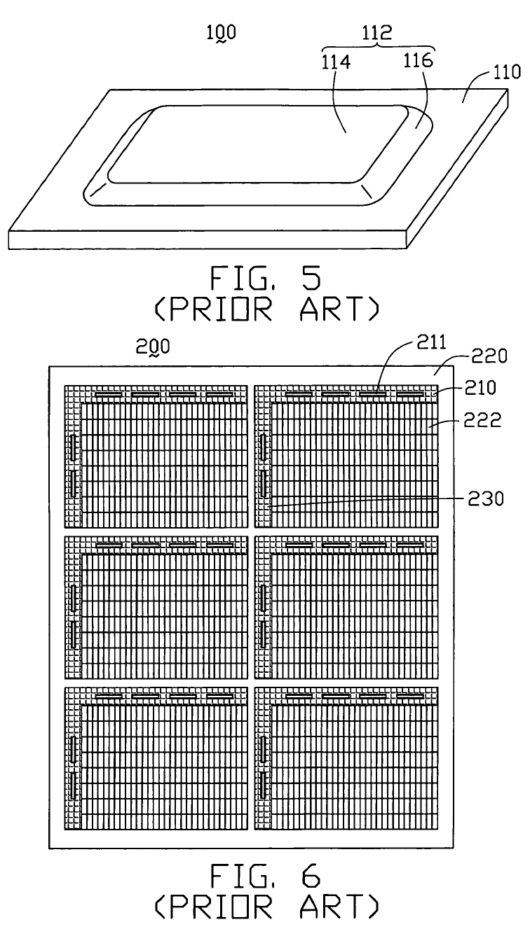

Referring to FIG. 4, this is a flow chart of an exemplary method for manufacturing the LTPS display panel 300. The method comprises the following steps. First, an insulative substrate (not labeled) and the display substrate 330 are provided (step 10). The insulative substrate is typically a glass substrate or a quartz substrate. Next, a first Plasma Enhanced Chemical Vapor Deposition (PECVD) is performed on a major surface of the insulative substrate, to form an amorphous silicon film (step 20). Then, an annealing process is performed to re-crystallize the amorphous silicon film to a poly-silicon film (step 30). The poly-silicon film comprises a plurality of source areas, a plurality of drain areas, and a plurality of channel areas of the LTPS TFTs. In the channel areas, a second PECVD is performed to form a silicon oxide layer on the poly-silicon film (step 40). A major constituent of the silicon oxide layer is tetra-ethyl-ortho-silicate (TEOS). The driving circuit substrate 310 is thus manufactured. The driving circuit substrate 310 comprises the plurality of driving circuits 311, and the display substrate 330 comprises the plurality of pixel units 322. According to production conditions and customer requests, the required amount of pixel units is cut from the display substrate 330 to form a display area, and a corresponding amount of driving circuits 311 is cut from the driving circuit substrate 310 to form a pair of driving circuit areas (step 50). Finally, the LTPS display panel 300 is made by connecting the display area and the driving circuit areas using the soft circuit boards 430 (step 60).

The requirement of the characteristic uniformity of the TFTs in the driving circuit area 210 is much higher than the requirement of the TFTs in the display panel area 230. The present invention provides a technology to manufacture the driving circuit areas and the display area separately, and to centralize the driving circuits in the same substrate. This approach reduces the impediment to uniformity that is caused by various different processes, and thus improves the yield rate and reduces production costs.

It is to be understood, however, that even though numerous characteristics and advantages of the present embodiments have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An LTPS (low temperature poly-silicon) display panel comprising:
a display area cut from a display substrate; and
a driving circuit area cut from a poly-silicon film formed on an insulated substrate;
wherein the driving circuit electrically connects to the display area.

2. The LTPS display panel of claim 1, wherein the insulated substrate is a glass substrate.

3. The LTPS display panel of claim 1, wherein the insulated substrate is a quartz substrate.

4. The LTPS display panel of claim 1, wherein the poly-silicon film is manufactured by an excimer laser annealing process.

5. The LTPS display panel of claim 1, wherein a surface of the poly-silicon film comprises a plurality of drain areas, a plurality of source areas, and a plurality of channel areas.

6. The LTPS display panel of claim 1, wherein the driving circuit area electrically connects to the display area via a soft circuit board.

7. The LTPS display panel of claim 1, wherein the driving circuit area electrically connects to the display area via a conducting material.

8. A method for manufacturing an LTPS (low temperature poly-silicon) display panel, comprising:
providing two substrates, wherein one is a display substrate and the other is an insulative substrate;
forming a poly-silicon film on the insulative substrate;
forming a plurality of driving circuits on the poly-silicon film;
forming a display area by cutting from the display substrate;
forming one or more driving circuit areas corresponding to the display area by cutting from the insulative substrate; and
electrically connecting the display area and the driving circuit areas.

9. The method of claim 8, wherein the insulative substrate is a glass substrate.

10. The method of claim 8, wherein the insulative substrate is a quartz substrate.

11. The method of claim 8, wherein the poly-silicon film is manufactured by an excimer laser annealing process.

12. The method of claim 8, wherein a surface of the poly-silicon film comprises a plurality of drain areas, a plurality of source areas, and a plurality of channel areas.

13. The method of claim 8, wherein the driving circuit areas are electrically connected to the display area by at least one soft circuit board.

14. The method of claim 8, wherein the driving circuit areas are electrically connected to the display area by a conducting material.

15. An LTPS (low temperature poly-silicon) display panel comprising:
one display area formed on a display substrate; and
one driving circuit area formed on an insulated substrate which is essentially different from the display substrate and essentially has nothing to do with the display substrate during manufacturing;
wherein the driving circuit electrically connects to the display area.

16. The LTPS display panel as claimed in claim 15, wherein said display substrate originally contains more than one said display areas.

17. The LTPS display panels as claimed in claim 16, wherein said insulated substrate originally contains more than one said driving circuit areas.

18. The LTPS display panels as claimed in claim 17, wherein said more than one said display areas are electrically connected to the more than one side driving circuit areas, respectively.
